(19) United States
(12) Patent Application Publication
(10) Pub. No.: US 2025/0216027 A1
(43) Pub. Date: Jul. 3, 2025

(54) FLEXIBLE DISPLAY DEVICE

(71) Applicant: LG DISPLAY CO., LTD., Seoul (KR)

(72) Inventors: ChangHee CHOI, Paju-si (KR); YoungKyu BANG, Paju-si (KR); YongIk HWANG, Paju-si (KR)

(73) Assignee: LG DISPLAY CO., LTD., Seoul (KR)

(21) Appl. No.: 18/944,741

(22) Filed: Nov. 12, 2024

(30) Foreign Application Priority Data
Dec. 28, 2023 (KR) 10-2023-0193842

(51) Int. Cl. F16M 13/02

(52) U.S. Cl. CPC F16M 13/022

(57) ABSTRACT

A flexible display device includes a plate bracket coupled to a rear surface of a back cover supporting a display panel, a large-diameter gear rotatably coupled to the plate bracket, a small-diameter gear coupled to a central portion of the large-diameter gear to rotate with the large-diameter gear in an interworking manner, first and second slider racks intermeshing with the small-diameter gear on the upper and lower sides to slide in two side directions of the back cover along with rotation of the large-diameter gear, a first arm plate coupled to the first slider rack to slide in an interworking manner with the first slider rack, and a second arm plate coupled to the second slider rack to slide in an interworking manner with the second slider rack.

### CROSS-REFERENCE TO RELATED APPLICATION

This application claims priority from Korean Patent Application No. 10-2023-0193842 filed on Dec. 28, 2023, which is hereby incorporated by reference for all purposes as if fully set forth herein.

### BACKGROUND

### Field of the Disclosure

The present disclosure relates to a flexible display device.

### Description of the Background

In general, flat panel display devices such as liquid crystal display devices, plasma display devices, field emission display devices, and light emitting display devices are being actively researched, but liquid crystal display devices and light emitting display devices are attracting attention due to their advantages of mass production technology, ease of operation, and high image quality.

In recent years, in addition to the need for research and development on a solution to the technical shortcomings of these flat panel display devices, the need for research and development on the structural aspects of flexible display products, such as curved and rolling types, which are more appealing to users, has been particularly emphasized.

However, to change the curvature of a display panel, these flexible display devices require a curvature-changing mechanism to be coupled to the back of the display panel, and due to the limitations of the curvature-changing mechanism, it has been difficult to realize a constant curvature from the center to both sides of the display panel.

In addition, it was difficult to quickly change the curvature of the display panel to various curvatures desired by the user while continuously maintaining the changed curvature, making it difficult to accommodate various needs of the user. Therefore, there is a need for research to solve the above problems.

### SUMMARY

Accordingly, the present disclosure is directed to a flexible display device that substantially obviates one or more of problems due to limitations and disadvantages described above.

More specifically, the present disclosure is to provide a flexible display device that allows a user to change the curvature of a display panel to a flat or curved shape with low power or no power.

The present disclosure is also to provide a flexible display device that allows a user to implement a desired curvature from the center to both sides of a display panel, regardless of the size of the display device, and accommodates user's various needs in an environmentally friendly manner.

The present disclosure is not limited thereto, and other challenges not mentioned will become apparent to those of ordinary skill in the art from the following description

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and in accordance with the present disclosure, as embodied and broadly described, a flexible display device includes a plate bracket coupled to a rear surface of a back cover supporting a display panel, a large-diameter gear rotatably coupled to the plate bracket and having a first guide slot and a second guide slot formed on the upper and lower sides in an arc shape about a center axis of rotation, a small-diameter gear coupled to a central portion of the large-diameter gear to rotate with the large-diameter gear in an interworking manner, a bracket rotary section rotatably coupled to the plate bracket to rotate with the large-diameter gear in an interworking manner and having a first slot and a second slot formed in the same arc shape as the first guide slot and the second guide slot, a first slider rack intermeshing with the small-diameter gear on the upper side to slide in two side directions of the back cover along with rotation of the large-diameter gear and having a first slide hole communicating with the first guide slot and the first slot, a second slider rack intermeshing with the small-diameter gear on the lower side to slide in two side directions of the back cover along with rotation of the large-diameter gear and having a second slide hole communicating with the second guide slot and the second slot, a first arm plate coupled to the first slider rack to slide in an interworking manner with the first slider rack, a second arm plate coupled to the second slider rack to slide in an interworking manner with the second slider rack, a first guide rod coupled through the first guide slot, the first slot, and the first slide hole, a second guide rod coupled through the second guide slot, the second slot, and the second slide hole, and a slider rack-support section having a first end coupled to the first guide rod and a second end coupled to the second guide rod to support the first slider rack and the second slider rack.

The present disclosure is to provide a flexible display device that allows a user to change the curvature of a display panel to a flat or curved shape with low power or no power.

The present disclosure is to provide a flexible display device that allows a user to implement a desired curvature from the center to both lateral sides of a display panel, regardless of the size of the display device, and accommodates user's various needs in an environmentally friendly manner.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure.

In the drawings:

FIG. 1 is a perspective diagram illustrating a flexible display device according to aspects of the present disclosure;

FIGS. 2 to 5 are perspective diagrams illustrating portions of the flexible display device according to aspects of the present disclosure;

FIGS. 6 and 7 are reference diagrams illustrating FIGS. 1 to 5;

FIG. 8 is a rear diagram illustrating an operational state of the flexible display device according to aspects of the present disclosure;

FIG. 9 is a cross-sectional diagram illustrating a portion of the flexible display device according to aspects of the present disclosure;

FIG. 10 is a cross-sectional diagram illustrating a portion of the flexible display device according to aspects of the present disclosure;

FIG. 11 is a reference diagram illustrating FIG. 10; and

FIG. 12 is a perspective diagram illustrating a portion of the flexible display device according to aspects of the present disclosure.

### DETAILED DESCRIPTION

In the following description of examples or aspects of the present disclosure, reference will be made to the accompanying drawings in which it is shown by way of illustration specific examples or aspects that may be implemented, and in which the same reference numerals and signs may be used to designate the same or like components even when they are shown in different accompanying drawings from one another. Further, in the following description of examples or aspects of the present disclosure, detailed descriptions of well-known functions and components incorporated herein will be omitted when it is determined that the description may make the subject matter in some aspects of the present disclosure rather unclear. The terms such as “including,” “having,” “containing,” “constituting,” “make up of” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A)” or “(B)” may be used herein to describe elements of the present disclosure. Each of these terms is not used to define essence, order, sequence, number of elements, etc., but is used merely to distinguish the corresponding element from other elements.

When it is mentioned that a first element “is connected or coupled to,” “contacts or overlaps,” etc. a second element, it should be interpreted that, not only may the first element “be directly connected or coupled to” or “directly contact or overlap” the second element, but a third element may also be “interposed” between the first and second elements, or the first and second elements may “be connected or coupled to,” “contact or overlap,” etc. each other via a fourth element. Here, the second element may be included in at least one of two or more elements that “are connected or coupled to,” “contact or overlap,” etc. each other.

When time relative terms, such as “after,” “subsequent to,” “next,” “before” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc. are mentioned, it should be considered that numerical values for elements or features, or corresponding information (e. g., level, range, etc.) include a tolerance or error range that may be caused by various factors (e. g., process factors, internal or external impact, noise, etc.) even when a relevant description is not specified. Further, the term “may” fully encompass all the meanings of the term “may.”

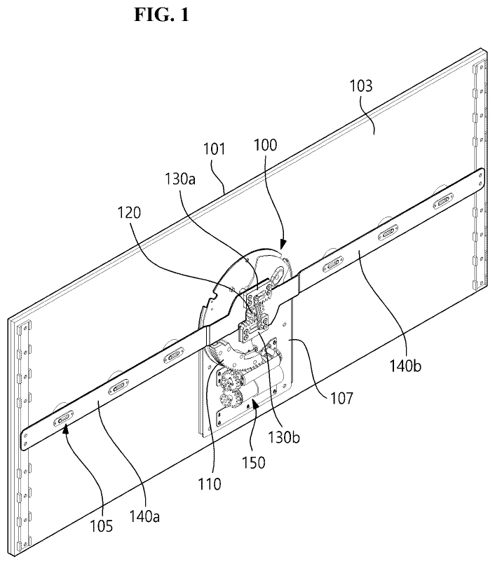

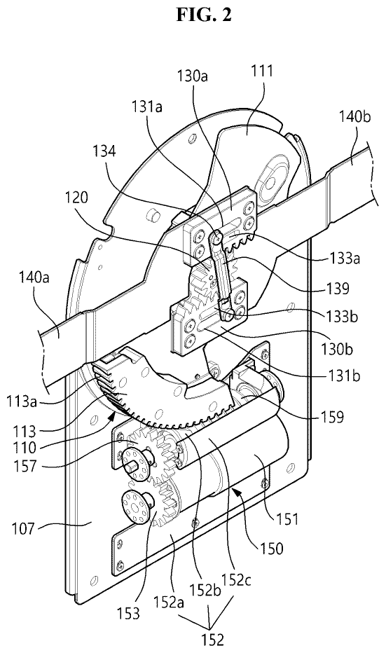

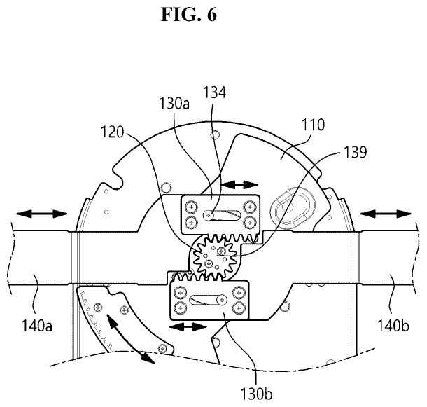

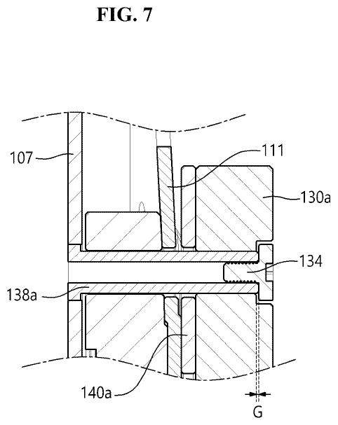

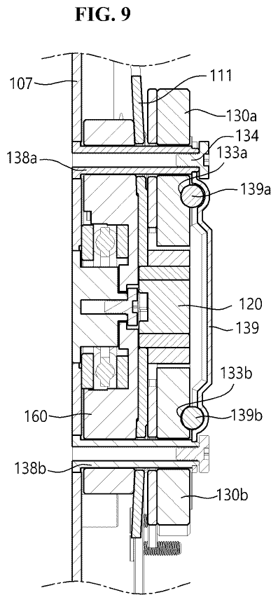

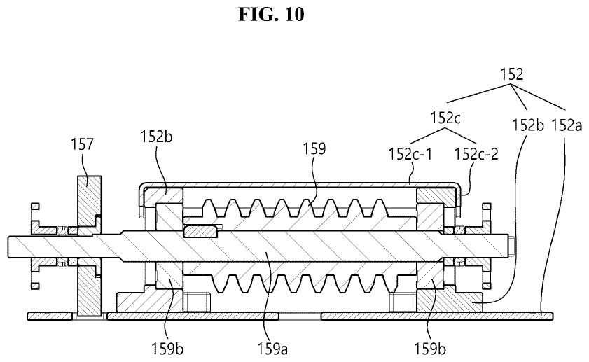

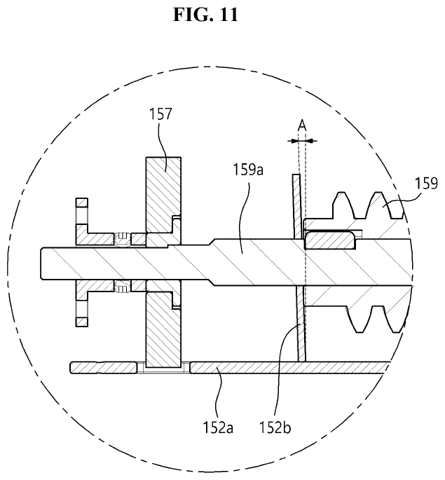

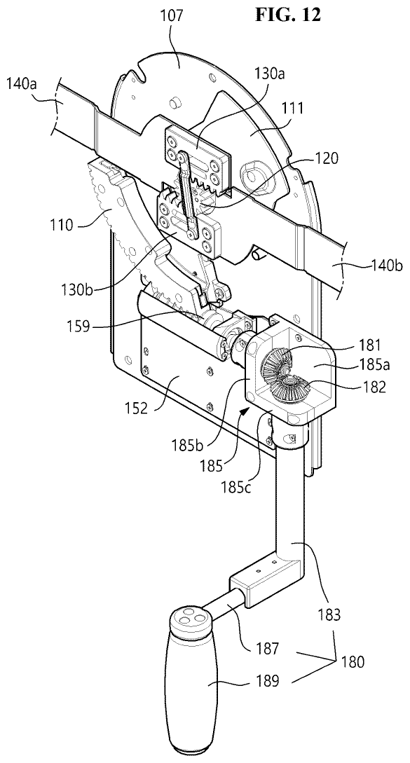

FIG. 1 is a perspective diagram illustrating a flexible display device according to aspects of the present disclosure, FIGS. 2 to 5 are perspective diagrams illustrating portions of the flexible display device according to aspects of the present disclosure, FIGS. 6 and 7 are reference diagrams illustrating FIGS. 1 to 5, FIG. 8 is a rear diagram illustrating an operational state of the flexible display device according to aspects of the present disclosure, FIG. 9 is a cross-sectional diagram illustrating a portion of the flexible display device according to aspects of the present disclosure, FIG. 10 is a cross-sectional diagram illustrating a portion of the flexible display device according to aspects of the present disclosure, FIG. 11 is a reference diagram illustrating FIG. 10, and FIG. 12 is a perspective diagram illustrating a portion of the flexible display device according to aspects of the present disclosure.

As illustrated in these drawings, the flexible display device according to aspects of the present disclosure includes a plate bracket 107 coupled to a rear surface of a back cover 103 supporting a display panel 101, a large-diameter gear 110 rotatably coupled to the plate bracket 107 and having a first guide slot 111a and a second guide slot 111b formed on the upper and lower sides in an arc shape about a center axis of rotation, a small-diameter gear 120 coupled to a central portion of the large-diameter gear 110 to rotate with the large-diameter gear 110 in an interworking manner, a bracket rotary section 160 rotatably coupled to the plate bracket 107 to rotate with the large-diameter gear 110 in an interworking manner and having a first slot 161a and a second slot 161b formed in the same arc shape as the first guide slot 111a and the second guide slot 111b, a first slider rack 130a intermeshing with the small-diameter gear 120 on the upper side to slide in two side directions of the back cover 103 along with rotation of the large-diameter gear 110 and having a first slide hole 131a communicating with the first guide slot 111a and the first slot 161a, a second slider rack 130b intermeshing with the small-diameter gear 120 on the lower side to slide in two side directions of the back cover 103 along with rotation of the large-diameter gear 110 and having a second slide hole 131b communicating with the second guide slot 111b and the second slot 161b, a first arm plate 140a coupled to the first slider rack 130a to slide in an interworking manner with the first slider rack, a second arm plate 140b coupled to the second slider rack 130b to slide in an interworking manner with the second slider rack, a first guide rod 138a coupled through the first guide slot 111a, the first slot 161a, and the first slide hole 131a, a second guide rod 138b coupled through the second guide slot 111b, the second slot 161b, and the second slide hole 131b, and a slider rack-support section 139 having a first end coupled to the first guide rod 138a and a second end coupled to the second guide rod 138b to support the first slider rack 130a and the second slider rack 130b.

First, in the case of direction-related references in aspects of the present disclosure, based on the assembly structure of the display panel 101 and the back cover 103, the display panel 101 side will be referred to as the front side, the back cover 103 side as the back side, and as illustrated in FIG. 1, when viewed in a direction towards the back cover 103, the left and right sides and the top and bottom of the drawing will be referred to as the left and right sides and the top and bottom.

It will also be understood that the first arm plate 140a and the second arm plate 140b disposed on the left and right sides of the back cover 103 may each be equipped with two or more arm plates, but in aspects of the present disclosure, the first arm plate 140a and the second arm plate 140b are illustrated with one each.

Further, while a bending module 100 provided in the center portion of the back surface of the back cover 103 may be directly coupled to the back surface of the back cover 103 or may be coupled via a separate plate bracket 107, aspects of the present disclosure will be described with reference to the case in which the bending module 100 is coupled to the back surface of the back cover 103 via the plate bracket 107 coupled to the back surface of the back cover 103.

Here, the bending module 100 refers to an assembly of components mounted on the back surface of the back cover 103.

Coupled to the front side of the back cover 103 is the display panel 101, which may be a liquid crystal display panel or an electroluminescent display panel according to aspects of the present disclosure.

That is, if the display panel 101 is a liquid crystal display panel, the display device may further include a backlight unit for irradiating light onto the liquid crystal display panel, a lower polarizer attached to a lower substrate, and an upper polarizer attached to the front of an upper substrate, wherein the lower substrate and the upper substrate may be configured in various forms known in the art, depending on a driving mode of the liquid crystal panel, such as a twisted nematic (TN) mode, a vertical alignment (VA) mode, an in-plane switching (IPS) mode, and a fringe field switching (FFS) mode.

Further, if the display panel 101 is a light-emitting display panel, the light-emitting display panel may include a lower substrate having a plurality of light-emitting cells respectively formed in regions defined by gate lines, data lines, and power (VDD) lines, and an upper substrate oppositely bonded to the lower substrate. Such configurations are well known in the art to which the present disclosure belongs, so drawings and detailed descriptions thereof will be omitted.

As such, the display panel 101 in aspects of the present disclosure may be used regardless of the type of display panel, and therefore will be described herein irrespective of the type of display panel.

In aspects of the present disclosure, the curvature of the display panel 101 is changed by the bending module 100 bending the back cover 103 while sliding the first arm plate 140a and the second arm plate 140b to the left and right, respectively, from the center of the back surface of the back cover 103 so that the display panel variably changes in radius of curvature between a flat state and a curved state.

Here, the first arm plate 140a and the second arm plate 140b are formed of a metal material such as an aluminum alloy or stainless steel having the rigidity enough to bend the display panel 101 and the back cover 103 and the elasticity enough to be elastically deformed to a predetermined curvature and restored back.

For example, in aspects of the present disclosure, the display panel and the back cover 103 may be bent to have the radius of curvature R of approximately 700 to 1000 mm.

Referring to FIGS. 1 to 3, the large-diameter gear 110 and the small-diameter gear 120, the first slider rack 130a and the second slider rack 130b, the first arm plate 140a and the second arm plate 140b, and the like are coupled on the upper side of plate bracket 107, and a drive section 150 for rotating the large-diameter gear 110 is coupled on the lower side of the plate bracket 107.

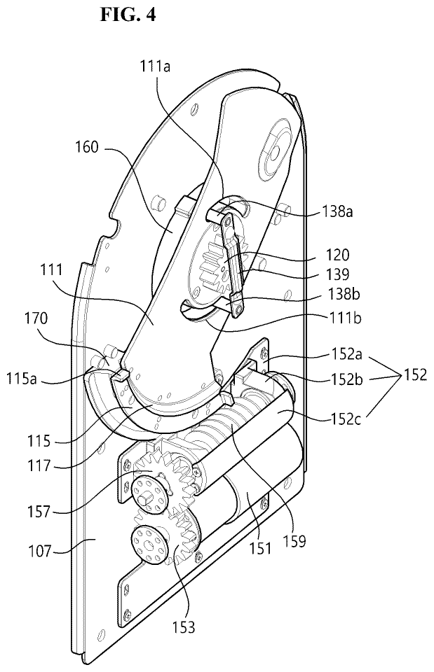

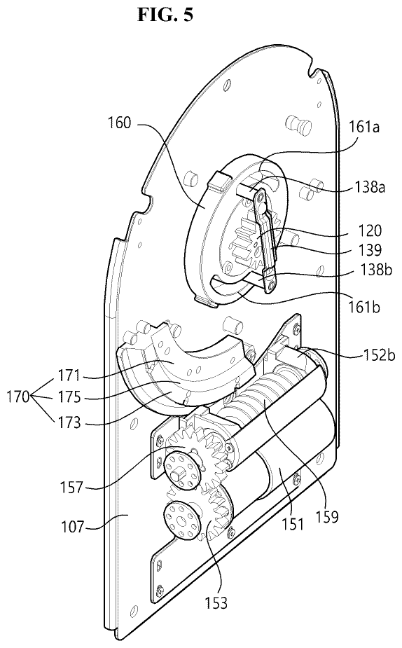

To support the rotation of the large-diameter gear 110 and the small-diameter gear 120, the bracket rotary section 160 is provided between the rotation center of the large-diameter gear 110 and the plate bracket 107 to be rotatably coupled to the plate bracket 107 as illustrated in FIGS. 4 and 5, so that the bracket rotary section is rotated with the large-diameter gear 110 in an interworking manner.

The large-diameter gear 110 includes a rotary plate part 111, which is coupled to the bracket rotary section 160, and to which the small-diameter gear 120 is coupled, and a large-diameter gear part 113 coupled to one end of the rotary plate part 111 and having gear teeth 113a on an arc-shaped outer circumferential surface.

As illustrated in FIG. 2, the large-diameter gear 110 rotates the small-diameter gear 120 in an interworking manner to slide the intermeshed first and second slider racks 130a and 130b to the left and right.

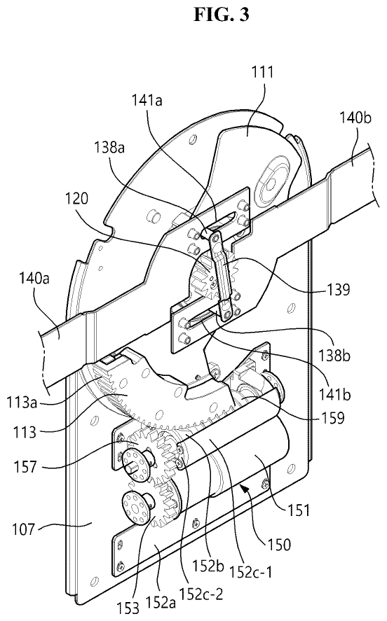

As illustrated in FIGS. 3 and 4, the rotary plate part 111 has an elongated plate shape which is formed by cutting off a portion of a disk and to which the small-diameter gear 120 is coupled in the central portion and the large-diameter gear part 113 is coupled to one end of the rotary plate part 111.

The large-diameter gear part 113 is formed in an arc shape and has the gear teeth 113a on its outer circumferential surface, with which a drive gear 159 to be described later intermeshes, so that the large-diameter gear part is rotated about the central axis of the small-diameter gear 120, along with the rotation of the drive gear 159.

One end of the rotary plate part 111 is provided with a gear attachment portion 115, which is stepped parallel to the rotary plate part 111 and extends rearward, as illustrated in FIG. 4, and to which the large-diameter gear part 113 is attached.

Further, the rotary plate part 111 and the stepped gear attachment portion 115 are connected with a radially-inclined connecting surface 117 with respect to the rotary plate part 111, thereby increasing the rigidity of the stepped gear attachment portion 115.

Thus, even if a high load of power is transmitted from the drive gear 159 to the large-diameter gear part 113, rotational power may be transmitted precisely without breakage or deformation of the rotary plate part 111 and the gear attachment portion 115.

Further, the circumferentially opposite ends of the gear attachment portion 115 are provided with support portions 115a, which are bent to wrap around and support circumferentially opposite sides of the large-diameter gear part as illustrated in FIG. 4.

The support portions 115a are formed in the shape of flanges bent vertically at both circumferential ends of the gear attachment portion 115 so that the circumferentially opposite sides of the large-diameter gear part 113 are closely abutted against and supported by the support portions.

Thus, when the large-diameter gear 110 is rotated with the rotation force of the drive gear 159, the large-diameter gear part 113 may transmit power precisely while maintaining a correct position without deviating circumferentially.

An arc-shaped large-diameter gear-guide section 170 is provided between the large-diameter gear part 113 and the plate bracket 107 to be fixed to the plate bracket 107 to guide the rotation of the large-diameter gear part 113, as illustrated in FIGS. 4 and 5.

The large-diameter gear-guide section 170 is formed in an arc shape corresponding to the large-diameter gear part 113 and guides the circumferential movement of the large-diameter gear part 113 during rotation of the large-diameter gear 110 while being fixed to the plate bracket 107, thereby maintaining a correct position of the large-diameter gear part 113 to realize a precise rotational position.

The large-diameter gear-guide section 170 includes a plate guide part 171 on which the rotary plate part 111 is supported, a gear guide part 173 stepped parallel to the plate guide part 171 to support the large-diameter gear part 113, and an inclined surface-support part 175 connecting the plate guide part 171 and the gear guide part 173 to support the inclined surface 117.

The plate guide part 171 and the gear guide part 173 are flat plates formed parallel to each other such that the plate guide part 171 supports the front surface of the rotary plate part 111 and the gear guide part 173 supports the front surface of the large-diameter gear part 113 during circumferential movement of the large-diameter gear 110.

Further, the inclined surface-support part 175 supports the inclined surface 117 connecting the rotary plate part 111 and the gear attachment part 115 during the circumferential movement of the large-diameter gear 110, allowing the large-diameter gear 110 to rotate while maintaining a correct position of the large-diameter gear part 113.

As illustrated in FIGS. 4 and 5, the rotary plate part 111 and the bracket rotary section 160 are provided with the first guide slot 111a and the first slot 161a, which are formed on the upper side of and in an arc shape around the center axis of the small-diameter gear 120, and the second guide slot 111b and the second slot 161b, which are disposed on the lower side of the small-diameter gear 120.

In more detail, as illustrated in FIG. 4, the first guide slot 111a and the second guide slot 111b are formed in an arc shape on the upper and lower sides, respectively, of the rotary plate part 111, and as illustrated in FIG. 5, the first slot 161a and the second slot 161b are formed in the bracket rotary section 160 in the same position and shape.

Further, the first guide rod 138a and the second guide rod 138b are respectively coupled through the first guide slot 111a and the first slot 161a, and the second guide slot 111b and the second slot 161b, which will be described later.

Thus, when the rotary plate part 111 and the bracket rotary section 160 rotate, the rotation is performed while the first guide rod 138a and the second guide rod 138b are respectively supported in and abutted against the first guide slot 111a/the first slot 161a and the second guide slot 111b/the second slot 161b.

Referring also to FIG. 2, the first slider rack 130a has the first slide hole 131a in communication with the first guide slot 111a and the first slot 161a, and the second slider rack 130b has the second slide hole 131b in communication with the second guide slot 111b and the second slot 161b.

Further, the first arm plate 140a and the second arm plate 140b are respectively provided with plate slots 141a, 141b, which are formed in the same shape and at the same location as the first slide hole 131a and the second slide hole 131b to be elongated in the left and right directions of the back cover 103.

As illustrated in FIGS. 4 and 5, the plate bracket 107 is fixed with the first guide rod 138a passing through the first guide slot 111a, the first slot 161a, and the first slide hole 131a, and the second guide rod 138b passing through the second guide slot 111b, the second slot 161b, and the second slide hole 131b.

Thus, when the large-diameter gear 110 rotates, the bracket rotary section 160 and the rotary plate part 111 are rotated while being supported by the first guide rod 138a and the second guide rod 138b, and the first arm plate 140a and the second arm plate 140b, and the first slider rack 130a and the second slider rack 130b slide while being supported by the first guide rod 138a and the second guide rod 138b.

Such aspects of the present disclosure may further include a slider rack-support section 139, which is coupled at one end to the first guide rod 138a and at the other end to the second guide rod 138b to support the first slider rack 130a and the second slider rack 130b toward the plate bracket 107.

That is, if the configuration has no slider rack-support section 139 as illustrated in FIGS. 6 and 7, when the first slider rack 130a and the second slider rack 130b slide in two side directions together with the first arm plate 140a and the second arm plate 140b, a convex bending toward the back of the back cover is created, which generates a force to enable the first slider rack 130a and the second slider rack 130b to deviate backward, and increases the frictional force, resulting in the possibility of generating noise.

In this case, the backward deviation of the first slider rack 130a is prevented by a fastener 134 fastened to the first guide rod 138a as illustrated in FIG. 7. The backward deviation-prevention force increases as a fastening gap G between the fastener 134 and the first slider rack 130a becomes smaller, so that the first slider rack 130a is stably supported, but on the other hand, the operating force required for sliding the first slider rack 130a in two side directions also increases.

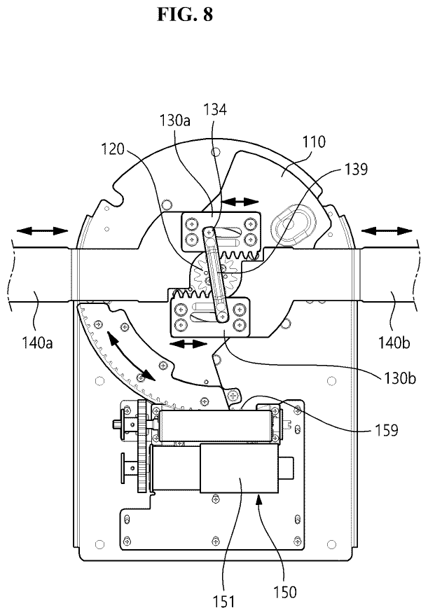

Therefore, to reduce the sliding operating force while preventing the first slider rack 130a and the second slider rack 130b from deviating therefrom, the slider rack-support section 139, as illustrated in FIGS. 8 and 9, is fixed to the first guide rod 138a and the second guide rod 138b to fasten and support the slider rack toward the plate bracket 107.

Further, the first slider rack 130a is provided with a first support groove 133a aligned with the first guide slot 111a and the first slot 161a, and one end of the slider rack-support section 139 is provided with a first roller 139a supported on the first support groove 133a.

Therefore, even if the slider rack-support section 139 supports the first slider rack 130a toward the plate bracket 107, during left and right sliding movements of the first slider rack 130a, a large amount of sliding operating force is not generated by the rolling motion of the first roller to allow for easy sliding movement.

Further, the second slider rack 130b is provided with a second support groove 133b aligned with the second guide slot 111b and the second slot 161b, and the other end of the slider rack-support section 139 is provided with a second roller 139b supported on the second support groove 133b. Therefore, even if the slider rack-support section 139 supports the second slider rack 130b toward the plate bracket 107, during left and right sliding movements of the second slider rack 130b, a large amount of sliding operating force is not generated by the rolling motion of the second roller to allow for easy sliding movement.

Here, the first roller 139a and the second roller 139b may be balls, rollers, or the like, and in aspects of the present disclosure, balls are provided as the first roller 139a and the second roller 139b as illustrated in FIG. 9.

The drive section 150 for rotating the large-diameter gear 110 includes a drive gear 159 intermeshing with the large-diameter gear 110, a first linkage gear 157 provided on one side of a shaft of the drive gear 159, a second linkage gear 153 intermeshing with the first linkage gear 157, a motor 151 for rotating the second linkage gear 153, and a drive section bracket 152 coupling the drive gear 159 and the motor 151 to the plate bracket 107.

In this case, the driving force of the motor 151 rotates the large-diameter gear 110 in such a manner that a motor shaft rotates the second linkage gear 153, and the first linkage gear 157 intermeshing therewith rotates the drive gear 159, causing the large-diameter gear 110 to rotate, so that the drive gear 159 does not directly rotate the small-diameter gear 120, but transmits the rotational force from the large-diameter gear 110 to the small-diameter gear 120, thereby enabling strong rotational torque to be transmitted at low power.

Here, referring to FIG. 1 to 5, together with FIG. 10, the drive section bracket 152 includes a fastening bracket 152a secured to the plate bracket 107, and a pair of drive gear brackets 152b coupled to the fastening bracket 152a and therefore to both ends of a shaft 159a of the drive gear 159 via bearings 159b.

The drive section bracket 152 may further include a support bracket 152c having a cylinder part 152c-1 disposed on an outer side of the drive gear 159 and fixing parts 152c-2 bent at both ends of the cylinder part 152c-1 and coupled to both outer ends of the drive gear brackets 152b.

In other words, when the drive gear 159 rotates the large-diameter gear 110, the repulsive force caused by the engagement with the large-diameter gear 110 transmits a reverse load in the left and right directions, i.e., the direction of the rotation shaft of the drive gear 159, which is prone to breakage or deformation of the drive gear brackets 152b coupled to both ends of the shaft 159a of the drive gear 159 as in the configuration without the support bracket as illustrated in FIG. 11.

In particular, when the drive gear brackets 152b are bent to a predetermined angle A due to the force of the drive gear 159 pushing the drive gear bracket 152b during forward and reverse rotation of the drive gear 159, the driving force of the motor for rotating the drive gear 159 becomes excessive.

Thus, as illustrated in FIG. 10, the fixing parts 152c-2 of the support bracket 152c are formed to be coupled to the outer ends of the drive gear brackets 152b and connected to the cylinder part 152c-1, so that the load in the left and right directions on the drive gear brackets 152b is supported by the fixing parts 152c-2 and the cylinder part 152c-1 to prevent breakage or deformation of the drive gear bracket 152b, thereby preventing bending of the drive gear brackets 152b and maintaining smooth rotation of the large-diameter gear 110.

The process of bending a display panel according to aspects of the present disclosure as described above will now be described with reference to FIG. 8.

FIG. 8 illustrates a state in which the display panel is in a flat state with the first arm plate 140a maximally slidably moved to the right and the second arm plate 140b maximally slidably moved to the left so that the large-diameter gear 110 and the small-diameter gear 120 are maximally rotated clockwise.

Here, when the motor 151 operates to rotate the large-diameter gear 110 counterclockwise, the small-diameter gear 120 also rotates counterclockwise, causing the first slider rack 130a and the first arm plate 140a to slide to the left, while the second slider rack 130b and the second arm plate 140b slide to the right, thereby bending the display panel.

For reference, while the first arm plate 140a and the second arm plate 140b may be provided with guide parts having horizontally-elongated slot holes, and the back cover 103 may be provided with a sliding support parts (see 105 of FIG. 1) having protrusions supported in these slot holes, such a configuration is known in the art, so a detailed description thereof will be omitted.

Further, the principle of sliding the first arm plate 140a and the second arm plate 140b on the back cover 103 to opposite sides to bend the back cover 103 and the display panel 101 is known in the art, so a description thereof will also be omitted.

Further, as illustrated in FIG. 8, the drive section for rotating the large-diameter gear 110 includes a drive gear 159 intermeshing with the large-diameter gear 110, a first engagement gear 181 provided at one end of the shaft of the drive gear 159, a second engagement gear 182 intermeshing with the first engagement gear 181, a lever assembly 180 rotating the second engagement gear 182, a drive section bracket 152 coupling the drive gear 159 to the plate bracket 107, and a lever bracket 185 coupling the first engagement gear 181 and the second engagement gear 182 to the drive section bracket 152.

In this case, the large-diameter gear 110 is rotated by a user's operation to manipulate the lever assembly 180.

Here, the lever bracket 185 includes a bracket attachment part 185a fastened to the drive section bracket 152, a first connection part 185b bent at the bracket attachment part 185a to support the first engagement gear 181 and the shaft of the drive gear 159, and a second connection part 185c provided perpendicular to the bracket attachment part 185a and the first connection part 185b to support the second engagement gear 182 and the lever assembly 180.

Since the lever bracket 185 is directly applied with the user's force to manipulate the lever assembly 180, the vertical connection of the bracket attachment part 185a, the first connection part 185b, and the second connection part 185c increases the rigidity of the entire lever bracket 185 to prevent deformation and breakage.

The bracket attachment part 185a is fixedly attached to the drive section bracket 152 through a surface contact, and the first connection part 185b is formed to extend toward the drive gear 159 so that a coupler (not shown) is embedded in the first connection part 185b to connect the first engagement gear 181 and the shaft of the drive gear 159.

In addition, the second connection part 185c provided perpendicular to the bracket attachment part 185a and the first connection part 185b is also formed to extend toward the lever assembly 180 such that a coupler connecting the second engagement gear 182 and a second shaft 183 of the lever is embedded therein.

The lever assembly 180 includes a first shaft 187 connected to a gripper 189, and a second shaft 183 perpendicularly connected to the first shaft 187 to be rotatably supported on the second connection part 185c and engaged with the second engagement gear 182.

In this case, the gripper 189 is arranged such that the first shaft 187 is perpendicularly connected to the second shaft 183 to increase the moment of rotation for rotating the large-diameter gear with the user's lever-manipulating force, thereby causing the second shaft 183 to rotate the second engagement gear 182 and the first engagement gear 181 intermeshing therewith to rotate the drive gear 159, causing the large-diameter gear 110 to rotate, so that the rotational force is transmitted to the small-diameter gear 120 without directly rotating the small-diameter gear 120, enabling strong torque to be transmitted with low power.

Aspects of the present disclosure may provide a flexible display device that allows a user to change the curvature of a display panel to a flat or curved shape with low power or no power.

Further, aspects of the present disclosure may provide a flexible display device that allows a user to implement a desired curvature from the center to both lateral sides of a display panel, regardless of the size of the display device, and accommodates user's various needs in an environmentally friendly manner.

The above description has been presented to enable any person skilled in the art to make and use the technical idea of the present disclosure, and has been provided in the context of a particular application and its requirements. Various modifications, additions and substitutions to the described aspects will be readily apparent to those skilled in the art, and the general principles defined herein may be applied to other aspects and applications without departing from the spirit and scope of the present disclosure. The above description and the accompanying drawings provide an example of the technical idea of the present disclosure for illustrative purposes only. That is, the disclosed aspects are intended to illustrate the scope of the technical idea of the present disclosure. Thus, it is intended that the present disclosure covers the modifications and variations of the aspects provided they come within the scope of the appended claims and their equivalents.

What is claimed is:

1. A flexible display device comprising:
a plate bracket coupled to a rear surface of a back cover supporting a display panel;
a large-diameter gear rotatably coupled to the plate bracket and having a first guide slot and a second guide slot respectively formed on the upper and lower sides in an arc shape about a center axis of rotation;
a small-diameter gear coupled to a central portion of the large-diameter gear to rotate with the large-diameter gear in an interworking manner;
a bracket rotary section rotatably coupled to the plate bracket to rotate with the large-diameter gear in an interworking manner and having a first slot and a second slot formed in the same arc shape as the first guide slot and the second guide slot;
a first slider rack intermeshing with the small-diameter gear on the upper side to slide in two side directions of the back cover along with rotation of the large-diameter gear and having a first slide hole communicating with the first guide slot and the first slot;
a second slider rack intermeshing with the small-diameter gear on the lower side to slide in two side directions of the back cover along with rotation of the large-diameter gear and having a second slide hole communicating with the second guide slot and the second slot;
a first arm plate coupled to the first slider rack to slide in an interworking manner with the first slider rack;
a second arm plate coupled to the second slider rack to slide in an interworking manner with the second slider rack;
a first guide rod coupled through the first guide slot, the first slot, and the first slide hole;
a second guide rod coupled through the second guide slot, the second slot, and the second slide hole; and
a slider rack-support section having a first end coupled to the first guide rod and a second end coupled to the second guide rod to support the first slider rack and the second slider rack.

2. The flexible display device of claim 1, wherein the large-diameter gear comprises:
a rotary plate part, which is coupled to the bracket rotary section, and to which the small-diameter gear is coupled; and
a large-diameter gear part coupled to one end of the rotary plate part and having gear teeth on an arc-shaped outer circumferential surface.

3. The flexible display device of claim 2, wherein one end of the rotary plate part is provided with a gear attachment portion, which is stepped parallel to the rotary plate part and to which the large-diameter gear part is attached.

4. The flexible display device of claim 3, wherein the stepped portion connecting the rotary plate part and the gear attachment portion is formed as an inclined surface.

5. The flexible display device of claim 3, wherein circumferentially opposite ends of the gear attachment portion are provided with support portions bent to wrap around and support circumferentially opposite sides of the large-diameter gear part.

6. The flexible display device of claim 4, wherein an arc-shaped large-diameter gear-guide section is provided between the large-diameter gear part and the plate bracket so as to be fixed to the plate bracket to guide the rotation of the large-diameter gear part.

7. The flexible display device of claim 6, wherein the large-diameter gear-guide section comprises:
a plate guide part on which the rotary plate part is supported;
a gear guide part stepped parallel to the plate guide part to support the large-diameter gear part; and
an inclined surface-support part connecting the plate guide part and the gear guide part to support the inclined surface.

8. The flexible display device of claim 1, wherein the first slider rack is provided with a first support groove aligned with the first guide slot, and one end of the slider rack-support section is provided with a first roller supported on the first support groove.

9. The flexible display device of claim 8, wherein the second slider rack is provided with a second support groove aligned with the second guide slot, and the other end of the slider rack-support section is provided with a second roller supported on the second support groove.

10. The flexible display device of claim 1, wherein the drive section for rotating the large-diameter gear comprises:
a drive gear intermeshing with the large-diameter gear;
a first linkage gear provided on one side of a shaft of the drive gear;
a second linkage gear intermeshing with the first linkage gear;
a motor operated to rotate the second linkage gear; and
a drive section bracket coupling the drive gear and the motor to the plate bracket.

11. The flexible display device of claim 10, wherein the drive section bracket comprises:
a fastening bracket secured to the plate bracket; and
a pair of drive gear brackets coupled to the fastening bracket and both ends of a shaft of the drive gear via bearings.

12. The flexible display device of claim 11, wherein the drive section bracket further comprises:
a support bracket having a cylinder part disposed on an outer side of the drive gear and fixing parts bent at both ends of the cylinder part and coupled to both outer ends of the drive gear brackets.

13. The flexible display device of claim 1, wherein the drive section for rotating the large-diameter gear comprises:
a drive gear intermeshing with the large-diameter gear;
a first engagement gear provided at one end of a shaft of the drive gear;
a second engagement gear intermeshing with the first engagement gear;
a lever assembly rotating the second engagement gear;
a drive section bracket coupling the drive gear to the plate bracket; and
a lever bracket coupling the first engagement gear and the second engagement gear to the drive section bracket.

14. The flexible display device of claim 13, wherein the lever bracket comprises:
a bracket attachment part fastened to the drive section bracket;
a first connection part bent at the bracket attachment part to support the first engagement gear and the shaft of the drive gear; and
a second connection part provided perpendicular to the bracket attachment part and the first connection part to support the second engagement gear and the lever assembly.

15. The flexible display device of claim 1, wherein the lever assembly comprises:
a first shaft connected to a gripper; and
a second shaft perpendicularly connected to the first shaft so as to be rotatably supported on the second connection part and engaged with the second engagement gear.
